(19) United States
(12) Patent Application Publication
(10) Pub. No.: US 2025/0324178 A1
(43) Pub. Date: Oct. 16, 2025

(54) PHOTOELECTRIC CONVERSION APPARATUS, PHOTOELECTRIC CONVERSION SYSTEM, MOVING BODY, EQUIPMENT, AND METHOD OF DRIVING PHOTOELECTRIC CONVERSION APPARATUS

(71) Applicant: CANON KABUSHIKI KAISHA, Tokyo (JP)

(72) Inventors: YU ARISHIMA, Kanagawa (JP); SEIICHIROU SAKAI, Kanagawa (JP)

(21) Appl. No.: 19/173,858

(22) Filed: Apr. 9, 2025

(30) Foreign Application Priority Data
Apr. 11, 2024 (JP) 2024-063924

(51) Int. Cl. H04N 25/78; H04N 23/63; H04N 25/709

(52) U.S. Cl. CPC H04N 25/78; H04N 23/63; H04N 25/709

(57) ABSTRACT

A photoelectric conversion apparatus includes a plurality of pixels arranged across a plurality of rows and a plurality of columns, a plurality of column circuits corresponding to the plurality of columns respectively, and a control portion. Each of the plurality of column circuits includes a comparison circuit including a first input node to which a pixel signal is input from a plurality of pixels in a column corresponding thereto, and a second input node to which a reference signal is input, and a buffer circuit including an output node for outputting the reference signal to the comparison circuit of the column corresponding thereto. The control portion is capable of controlling a potential of the output node of the buffer circuit included in each of the plurality of column circuits to a predetermined potential.

### BACKGROUND OF THE INVENTION

### Field of the Invention

The present invention relates to a photoelectric conversion apparatus, a photoelectric conversion system, a moving body, equipment, and a method of driving a photoelectric conversion apparatus.

### Description of the Related Art

A photoelectric conversion apparatus is known that is equipped with a column-parallel analog-to-digital (AD) converter having an AD conversion portion for each pixel column. A typical column-parallel AD converter converts a pixel signal into digital data by comparing, by using a comparison circuit, the pixel signal with a reference signal, which changes in level over time, and by counting the time from the start of the comparison to the inversion of the output signal of the comparison circuit.

Japanese Patent Application Publication No. 2023-111095 describes a photoelectric conversion apparatus configured to reduce the settling time of the reference signal by connecting a buffer circuit between a reference signal line and a comparison circuit.

However, with the photoelectric conversion apparatus described in Japanese Patent Application Publication No. 2023-111095, no consideration is given to the handling of an output node itself that becomes floating when a part of the buffer circuit between the reference signal line and the comparison circuit is powered off.

### SUMMARY OF THE INVENTION

It is an object of the present invention to provide a technique capable of reducing deterioration in image quality caused by fluctuations of a floating output node.

According to some embodiments, a photoelectric conversion apparatus includes a plurality of pixels arranged across a plurality of rows and a plurality of columns; a plurality of column circuits corresponding to the plurality of columns respectively; and a control portion, wherein each of the plurality of column circuits includes a comparison circuit including a first input node to which a pixel signal is input from a plurality of pixels in a column corresponding thereto, and a second input node to which a reference signal is input, and a buffer circuit including an output node for outputting the reference signal to the comparison circuit of the column corresponding thereto, and the control portion is capable of controlling a potential of the output node of the buffer circuit included in each of the plurality of column circuits to a predetermined potential.

According to some embodiments, a photoelectric conversion system includes the photoelectric conversion apparatus as described above and a signal processing portion configured to generate an image by using a signal output from the photoelectric conversion apparatus.

According to some embodiments, a moving body includes the photoelectric conversion apparatus as described above, the moving body includes a control portion configured to control movement of the moving body by using a signal output from the photoelectric conversion apparatus.

According to some embodiments, equipment includes the photoelectric conversion apparatus as described above, and at least any of: an optical apparatus corresponding to the photoelectric conversion apparatus, a control apparatus that controls the photoelectric conversion apparatus, a processing apparatus that processes a signal output from the photoelectric conversion apparatus, a display apparatus that displays information obtained by the photoelectric conversion apparatus, a storage apparatus that stores information obtained by the photoelectric conversion apparatus, and a mechanical apparatus that operates on a basis of information obtained by the photoelectric conversion apparatus.

According to some embodiments, a method of driving a photoelectric conversion apparatus, wherein the photoelectric conversion apparatus includes a plurality of pixels arranged across a plurality of rows and a plurality of columns, a plurality of column circuits corresponding to the plurality of columns respectively, and a control portion, each of the plurality of column circuits includes a comparison circuit including a first input node to which a pixel signal is input from a plurality of pixels in a column corresponding thereto, and a second input node to which a reference signal is input, and a buffer circuit including an output node for outputting the reference signal to the comparison circuit of the column corresponding thereto, and the method includes controlling the buffer circuit by the control portion between a first state in which the buffer circuit operates and a second state in which a power consumption of the buffer circuit is less than that in the first state, and setting by the control portion a potential of the output node of the buffer circuit to a predetermined potential during a period in which the buffer circuit is controlled to the second state.

Further features of the present invention will become apparent from the following description of exemplary embodiments with reference to the attached drawings.

### BRIEF DESCRIPTION OF THE DRAWINGS

FIG. 1 is a circuit block diagram according to a first embodiment.

FIG. 2 is a diagram of the configuration of a unit pixel portion according to the first embodiment.

FIG. 3 is a diagram of the configuration of a column circuit portion according to the first embodiment.

FIG. 4 shows an example of the configuration of a buffer circuit according to the first embodiment.

FIG. 5 shows an example of the connection between the buffer circuit and a comparison circuit according to the first embodiment.

FIG. 6 is a timing diagram (part 1) according to the first embodiment.

FIG. 7 is a timing diagram (part 2) according to the first embodiment.

FIG. 8 is a diagram illustrating readout row scanning according to a second embodiment.

FIG. 9 is a diagram illustrating a photoelectric conversion system according to a third embodiment.

FIGS. 10A and 10B are diagrams illustrating a photoelectric conversion system and a moving body according to a fourth embodiment.

FIG. 11 is a diagram illustrating a distance image sensor according to a fifth embodiment.

FIG. 12 is a diagram illustrating an endoscopic surgery system according to a sixth embodiment.

FIGS. 13A and 13B are diagrams illustrating smart glasses according to a seventh embodiment.

FIGS. 14A and 14B are diagrams illustrating an electronic device according to an eighth embodiment.

FIG. 15 is a diagram illustrating equipment according to a ninth embodiment.

### DESCRIPTION OF THE EMBODIMENTS

Referring to the drawings, embodiments of the present invention are now described.

### First Embodiment

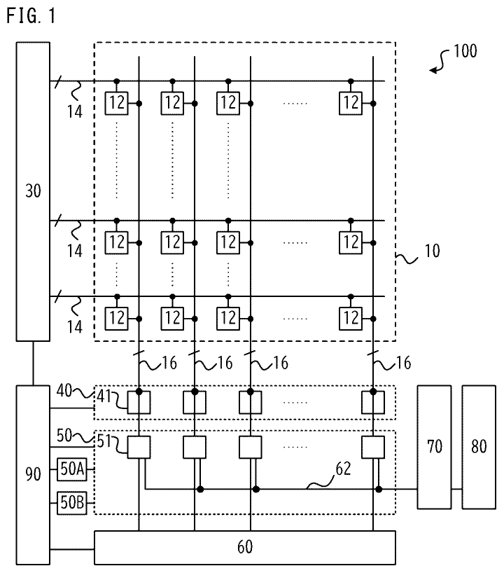

In the embodiments described below, an imaging apparatus is mainly described as an example of a photoelectric conversion apparatus. However, the embodiments are not limited to an imaging apparatus, and can also be applied to other examples of photoelectric conversion apparatuses. For example, the embodiments are applicable to distance measuring devices (devices for distance measurement using focus detection and Time of Flight (TOF)), photometry devices (devices for measuring the amount of incident light), and the like. Referring to FIG. 1, the block configuration of an imaging apparatus to which the present invention is applied is described. As shown in FIG. 1, an imaging apparatus 100 according to this embodiment includes a pixel region 10, a vertical drive circuit 30, and an output line drive circuit portion 40. The imaging apparatus 100 also includes a column circuit portion 50, a reference signal generating circuit 50A, a horizontal drive circuit 60, a signal processing portion 70, an output circuit 80, and a system control portion 90 (may also be referred to simply as a control portion).

The pixel region 10 includes multiple unit pixels 12 (may also be referred to simply as multiple pixels) arranged in a matrix across multiple rows and multiple columns. Each of the unit pixels 12 includes a photoelectric conversion portion formed by a photoelectric conversion element such as a photodiode, and outputs a pixel signal according to the amount of incident light. In addition to effective pixels that output pixel signals according to the amount of incident light, the pixel region 10 may also include optical black pixels having photoelectric conversion portions that are shielded from light, dummy pixels that do not output signals, and the like. There is no particular limitation to the number of rows and columns of the pixel array arranged in the pixel region 10.

A control line 14 is arranged in each row of the pixel region 10, extending in a first direction (the lateral direction in FIG. 1). Each control line 14 is connected to the corresponding unit pixels 12 aligned in the first direction, and serves as a signal line common to these unit pixels 12. The first direction in which the control lines 14 extend may be referred to as a row direction or a horizontal direction. Each of the control lines 14 may include multiple signal lines. The control lines 14 are connected to the vertical drive circuit 30.

In each column of the pixel regions 10, a vertical output line 16 is arranged, extending in a second direction (the longitudinal direction in FIG. 1) intersecting the first direction. Each of the vertical output lines 16 is connected to the corresponding unit pixels 12 aligned in the second direction, and serves as a signal line common to these unit pixels 12. The second direction in which the vertical output lines 16 extend may be referred to as a column direction or a vertical direction. Each of the vertical output lines 16 includes multiple output lines. The vertical output lines 16 are connected to the output line drive circuit portion 40.

The vertical drive circuit 30 is a control circuit that has a function of receiving a control signal supplied from the system control portion 90, generating a control signal for driving the unit pixels 12, and supplying the control signal to the unit pixels 12 via the control lines 14. The vertical drive circuit 30 may include logic circuits such as a shift register and an address decoder. The vertical drive circuit 30 sequentially supplies control signals to the control lines 14 of the respective rows, and sequentially drives the unit pixels 12 in the pixel region 10 row by row.

The signals read out from the unit pixels 12 on a row-by-row basis are input to the output line drive circuit portion 40 via vertical output lines 16 provided in the respective columns of the pixel region 10. The output line drive circuit portion 40 has multiple drive circuits 41, each corresponding to one of the multiple output lines forming the vertical output lines 16 of the respective columns of the pixel region 10. The output line drive circuit portion 40 is a control circuit having a function of receiving a control signal supplied from the system control portion 90 and controlling the connection between the pixel region 10 and the column circuit portion 50 and the potential of the vertical output lines 16.

The column circuit portion 50 includes multiple column circuits 51, each corresponding to one of the multiple output lines forming the vertical output lines 16 of the respective columns of the pixel region 10. Each column circuit 51 includes a processing circuit and a signal holding circuit. The processing circuit has a function of performing predetermined signal processing on the pixel signal output via the corresponding output line. Examples of the signal processing performed by the processing circuit include amplification processing, correction processing through correlated double sampling (CDS), and analog-to-digital conversion (AD conversion) processing. The signal holding circuit functions as a memory for holding the pixel signals processed by the processing circuit.

The reference signal generating circuit 50A is connected to the column circuit portion 50. The reference signal generating circuit 50A receives a control signal output from the system control portion 90, generates a reference signal to be used for AD conversion, and is connected to each column circuit 51 in the column circuit portion 50. The reference signal used for AD conversion may be a signal that has a predetermined amplitude according to the range of the pixel signal, and changes in signal level with time. There is no particular limitation to the reference signal. For example, a ramp signal with a signal level that increases or decreases with time can be applied.

A counter circuit 50B is connected to the column circuit portion 50. The counter circuit 50B has a function of performing a count operation in response to a control signal output from the system control portion 90, and outputting a count signal indicating the count value to the column circuit portion 50. The counter circuit 50B starts a count operation in synchronization with the timing at which the signal level of the reference signal supplied from the reference signal generating circuit 50A starts to change.

The horizontal drive circuit 60 is a control circuit that has a function of receiving a control signal supplied from the system control portion 90, generating a control signal for reading out pixel signals from the column circuit portion 50, and supplying the control signal to the column circuit portion 50. The horizontal drive circuit 60 sequentially scans the column circuits 51 of the column circuit portion 50, and causes the pixel signals held in the respective column circuits 51 to be sequentially output to the signal processing portion 70. The horizontal drive circuit 60 may include logic circuits such as a shift register and an address decoder.

The signal processing portion 70 has a function of performing predetermined signal processing on the pixel signals transferred from the column circuit portion 50. Examples of the processing performed by the signal processing portion 70 include arithmetic processing, amplification processing, and correction processing through CDS.

The output circuit 80 includes an external interface circuit, and is a circuit for outputting the signal processed by the signal processing portion 70 to the outside of the imaging apparatus 100. There is no particular limitation to the external interface circuit included in the output circuit 80. It may be a low voltage differential signaling (LVDS) circuit, a scalable low voltage signaling (SLVS) circuit, and the like. These SerDes (Serializer/Deserializer) transmission circuits are applicable.

The system control portion 90 is a control circuit that generates control signals for controlling the operations of the vertical drive circuit 30, the output line drive circuit portion 40, the column circuit portion 50, the horizontal drive circuit 60, and the like, and supplies them the respective functional blocks. The control signals that control the operation of the vertical drive circuit 30, the output line drive circuit portion 40, the column circuit portion 50, the horizontal drive circuit 60, and the like do not necessarily have to be supplied from the system control portion 90, and at least some of these may be supplied from outside the imaging apparatus 100. In FIG. 1, the signal paths are illustrated below the pixel region 10, but the signal paths are not limited to this. A circuit relating to signal paths may be provided above the pixel region 10.

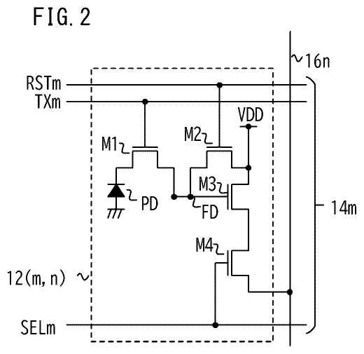

Referring to FIG. 2, an example of the configuration of the unit pixel 12 in the imaging apparatus according to the present embodiment is now described. FIG. 2 illustrates a unit pixel 12 (m, n) that is located in the mth row and nth column among the multiple unit pixels 12 forming the pixel region 10. Here, m is an integer from 1 to M, and n is an integer from 1 to N. The circuit configuration of the other unit pixels 12 forming the pixel region 10 may be similar to that of the unit pixel 12 (m, n).

As shown in FIG. 2, for example, the unit pixel 12 (m, n) may include a photoelectric conversion element PD, a transfer transistor M1, a reset transistor M2, an amplification transistor M3, and a selection transistor M4. The unit pixel 12 (m, n) may include a microlens and a color filter disposed on the optical path along which incident light is guided to the photoelectric conversion element PD. The microlens focuses the incident light onto the photoelectric conversion element PD. The color filter selectively transmits light of a predetermined color. The photoelectric conversion element PD may be a photodiode, for example.

The photoelectric conversion element PD has an anode connected to a reference voltage node and a cathode connected to the source of the transfer transistor M1. The drain of the transfer transistor M1 is connected to the source of the reset transistor M2 and the gate of the amplification transistor M3. A node FD to which the drain of the transfer transistor M1, the source of the reset transistor M2, and the gate of the amplification transistor M3 are connected is what is called a floating diffusion portion. The floating diffusion portion includes a capacitance component (floating diffusion capacitance) and functions as a charge storage portion. The floating diffusion capacitance may include a pn junction capacitance and a wiring capacitance.

The drain of the reset transistor M2 and the drain of the amplification transistor M3 are connected to a node to which a power supply voltage (voltage VDD) is supplied. The source of the amplification transistor M3 is connected to the drain of the selection transistor M4. The source of the selection transistor M4 is connected to the vertical output line 16n.

In the circuit configuration of FIG. 2, the control line 14m of each row includes three signal lines connected to the gate of the transfer transistor M1, the gate of the reset transistor M2, and the gate of the selection transistor M4. A control signal TXm is supplied from the vertical drive circuit 30 to the gate of the transfer transistor M1 of the unit pixels 12 in the mth row. A control signal RSTm is supplied from the vertical drive circuit 30 to the gate of the reset transistor M2 of each unit pixel 12 in the mth row. A control signal SELm is supplied from the vertical drive circuit 30 to the gate of the selection transistor M4 of each unit pixel 12 in the mth row. When each transistor is an N-type MOS transistor, a high-level control signal supplied from the vertical drive circuit 30 turns on the corresponding transistor. Also, a low-level control signal supplied from the vertical drive circuit 30 turns off the corresponding transistor.

In this embodiment, it is assumed that, of the electron-hole pairs generated in the photoelectric conversion element PD by the incidence of light, the electrons are used as the signal charge. When electrons are used as the signal charge, each transistor forming the unit pixel 12 may be an N-type MOS transistor. However, the signal charge is not limited to electrons, and holes may also be used as the signal charge. When holes are used as the signal charge, the conductivity type of each transistor is the opposite of that described in this embodiment. The names of the source and drain of a MOS transistor may differ depending on the conductivity type of the transistor and the function of interest. Some or all of the names of the source and drain used in this embodiment may be reversed.

The photoelectric conversion element PD converts incident light into an electric charge in an amount corresponding to the amount of light (photoelectric conversion), and accumulates the generated electric charge. When the transfer transistor M1 is turned on, it transfers the electric charge held in the photoelectric conversion element PD to the node FD. The electric charge transferred from the photoelectric conversion element PD is held in the capacitance of the node FD (floating diffusion capacitance). As a result, the node FD has a potential according to the amount of electric charge transferred from the photoelectric conversion element PD through charge-voltage conversion by the floating diffusion capacitance.

The selection transistor M4, when turned on, connects the amplification transistor M3 to the vertical output line 16n. The amplification transistor M3 has a drain to which a voltage VDD is supplied, and a source to which a bias current is supplied from a current source (not shown, a drive circuit 41 described below) via the selection transistor M4. The amplification transistor M3 forms an amplification portion (source follower circuit) with the gate as an input node. Thus, the amplification transistor M3 outputs a signal based on the voltage of the node FD to the vertical output line 16n via the selection transistor M4. In this sense, the amplification transistor M3 and the selection transistor M4 are output portions that output a pixel signal according to the amount of electric charge held in the node FD.

The reset transistor M2 has a function of controlling the supply of a voltage (voltage VDD) to the FD node for resetting the node FD as the charge storage portion. The reset transistor M2, when turned on, resets the node FD to a voltage corresponding to the voltage VDD. At this time, by simultaneously turning on the transfer transistor M1, it is also possible to reset the photoelectric conversion element PD to a voltage corresponding to the voltage VDD. By appropriately controlling the transfer transistor M1, the reset transistor M2, and the selection transistor M4, a signal corresponding to the reset voltage of the node FD and a signal corresponding to the amount of light incident on the photoelectric conversion element PD are read out from each unit pixel 12. Although the unit pixel 12 of this embodiment has one photoelectric conversion element PD, multiple photoelectric conversion elements may share one node FD. Additionally, the configuration is not limited to the above.

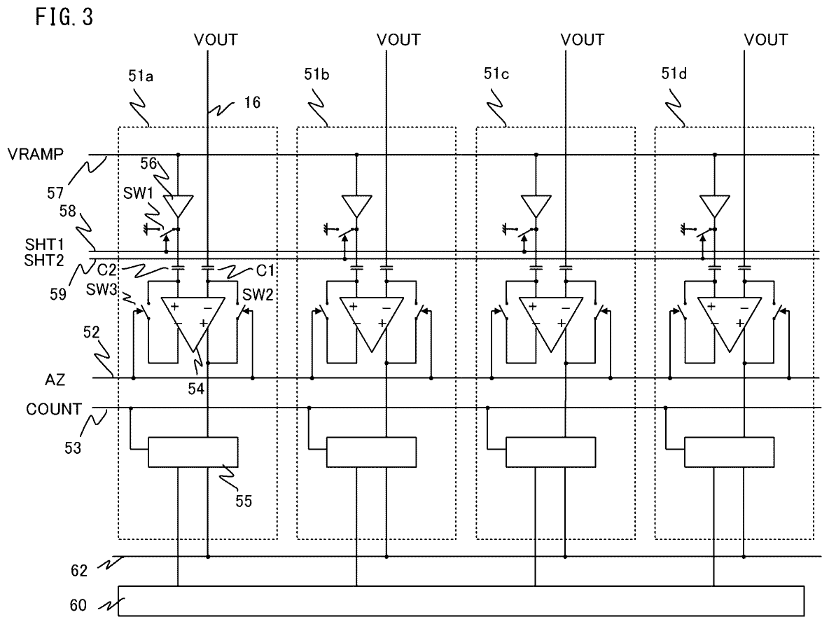

FIG. 3 illustrates multiple column circuits 51 forming the column circuit portion 50. For example, each column circuit 51 includes a buffer circuit 56, a comparison circuit 54, a memory portion 55, capacitors C1 and C2, and switches SW1, SW2, and SW3.

The buffer circuit 56 includes an input node and an output node. The input node of the buffer circuit 56 is connected to a reference signal line 57. A reference signal VRAMP is supplied to the input node of the buffer circuit 56 from the reference signal generating circuit 50A via the reference signal line 57. The output node of the buffer circuit 56 is connected to one electrode of the capacitor C2. A switch SW1 is connected between GND and the connection node between the buffer circuit 56 and the capacitor C2. The switch SW1 provided at the output node of each of the multiple buffer circuits receives control signals SHT1 and SHT2 independently from the system control portion 90 via signal lines 58 and 59.

The comparison circuit 54 may be a differential amplification circuit, for example, and includes a non-inverting input node (+), an inverting input node (−), a non-inverting output node (+), and an inverting output node (−). The inverting input node of the comparison circuit 54 is connected to the other electrode of the capacitor C1. A signal VOUT is supplied to the inverting input node (may also be referred to as a first input node) of the comparison circuit 54 from the vertical output line 16 via the capacitor C1.

A non-inverting input node (may also be referred to as a second input node) of the comparison circuit 54 is connected to the other electrode of the capacitor C2. A reference signal VRAMP is supplied to the non-inverting input node of the comparison circuit 54 from the reference signal line 57 via the buffer circuit 56 and the capacitor C2. A switch SW2 is connected between the inverting input node and the non-inverting output node of the comparison circuit 54. A switch SW3 is connected between the non-inverting input node and the inverting output node of the comparison circuit 54. The switches SW2 and SW3 are controlled by a control signal AZ supplied from the system control portion 90 via an AZ signal line 52. The switches SW2 and SW3 are reset switches for resetting the threshold voltage of the comparison circuit 54.

The comparison circuit 54 compares the level of the signal VOUT supplied from the vertical output line 16 via the capacitor C1 with the level of the reference signal VRAMP supplied from the reference signal line 57 via the buffer circuit 56 and the capacitor C2, and outputs a signal according to the result of the comparison. For example, when the level of the reference signal VRAMP is lower than the level of the signal VOUT, the comparison circuit 54 outputs a high-level signal. When the level of the reference signal VRAMP is higher than the level of the signal VOUT, the comparison circuit 54 outputs a low-level signal. The relationship between the magnitude relation of the input signals and the level of the output signal may be reversed.

Note that the comparison circuit 54 is not limited to the configuration shown in the figure, as long as it has a node to which a pixel signal is input and a node to which a reference signal is input, and is capable of performing an offset clamp operation that sets an offset based on the voltages of the pixel signal and the reference signal.

The memory portion 55 holds, as digital data of the pixel signal, the count value indicated by the count signal COUNT supplied from the counter circuit 50B at the time point when the non-inverting output node level of the comparison circuit 54 is inverted. The held digital data of each column is sequentially transferred to the signal processing portion 70 via a horizontal output line 62 in response to a control signal supplied from the horizontal drive circuit 60. The function of the counter circuit 50B may be provided inside the memory portion 55.

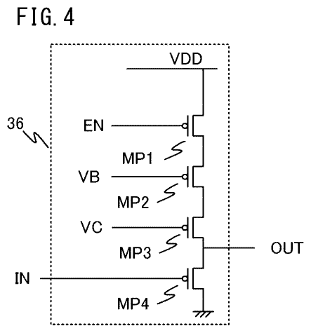

FIG. 4 shows an example of the buffer circuit 56. The buffer circuit 56 includes P-type transistors MP1, MP2, MP3, and MP4. The source of the P-type transistor MP1 is connected to a node to which the power supply voltage (voltage VDD) is supplied. The drain of the P-type transistor MP1 is connected to the source of the P-type transistor MP2. The drain of the P-type transistor MP2 is connected to the source of the P-type transistor MP3. The drain of the P-type transistor MP3 is connected to the source of the P-type transistor MP4. The drain of the P-type transistor MP4 is connected to the reference voltage node. An operation enable signal EN controlled by the system control portion 90 (control portion) is supplied to the gate of the P-type transistor MP1. When the operation enable signal EN is at the first level (low level), the buffer circuit 56 is in a power-on state. When the operation enable signal EN is at the second level (high level), the buffer circuit 56 is in a power-off state. The power-off state includes a mode in which the source and drain of the P-type transistor MP1 are nonconducting, but there is no limitation to this mode. That is, the power-off state also includes a state in which the current flowing between the source and drain of the P-type transistor MP1 is less than that in the power-on state. A bias voltage VB is supplied to the gate of the P-type transistor MP2. A bias voltage VC is supplied to the gate of the P-type transistor MP3. The gate of the P-type transistor MP4 is the input node IN of the buffer circuit 56. The connection node between the drain of the P-type transistor MP3 and the source of the P-type transistor MP4 is the output node OUT of the buffer circuit 56. The P-type transistor MP3 is configured so that a bias voltage VC is supplied to its gate, and operates as a cascode transistor. The P-type transistor MP3 forms a source follower together with the P-type transistor MP2, which operates as a current source, and buffers the signal (reference signal VRAMP) supplied from the input node IN and outputs it from the output node OUT. That is, the buffer circuit 56 buffers the reference signal VRAMP and outputs it to the comparison circuit 54.

In particular, to perform a thinning-out operation of column circuits, the unused column circuits may be powered off for power saving. For example, a switch SW1 is provided at the output node of each buffer circuit 56 (see FIG. 3). SW1 has a function of fixing the output node of the buffer circuit 56 to GND. FIG. 3 shows an example in which the output node is fixed to GND, but it does not necessarily have to be GND. Depending on the configuration of the buffer circuit 56, VDD or an intermediate potential may be used. In this specification, power-off includes a mode in which the power consumption is reduced to zero. However, power-off is not limited to this. In other words, power-off also includes a mode in which power consumption is less than that in the power-on state. When the power consumption is less than that in the power-on state, the time required for the column circuit to change from the power-off state to the power-on state can be shortened compared to when the power consumption is reduced to zero. Furthermore, powering off the column circuit includes powering off all components of the column circuit, but is not limited to this. For example, it includes a situation where the buffer circuit in the column circuit is powered off, but other circuits, such as the comparison circuit, are powered on. In the embodiment described below, in the power-off state of the column circuit, it is sufficient that at least the buffer circuit 56 is set to consume less power than in the power-on state. However, as described above, the power-off state of the column circuit requires that at least the buffer circuit 56 is in the power-off state, and the comparison circuit 54 may also be in the power-off state. In this specification, a state in which the buffer circuit 56 operates may be referred to as a first state, and a state in which the power consumption of the buffer circuit 56 is less than that in the first state may be referred to as a second state.

In an example in which some of the column circuits are thinned out to save power, the column circuits 51a and 51c in odd-numbered columns may be set as power-on columns, and the column circuits 51b and 51d in even-numbered columns may be set as power-off columns. That is, the column circuits of either of even-numbered columns or odd-numbered columns are powered on, while the column circuits of the other are powered off. At this time, the outputs of the buffer circuits 56 in the column circuits 51b and 51d become floating. Consequently, if a potential fluctuation in the column circuit 51a is picked up and crosstalk occurs in the column circuit 51c, this may cause noise deterioration. Thus, by turning on the switch SW1 to prevent floating, it is possible to reduce deterioration in image quality. The imaging apparatus 100 of this embodiment may have a configuration in which all of the above-mentioned circuit blocks are arranged on a single substrate, or may be configured as a stacked type in which multiple substrates are stacked together, with separate circuit blocks being created on each substrate.

Furthermore, the output node of the buffer circuit 56 has capacitive coupling with the input gate (reference signal VRAMP). That is, in all columns, capacitive coupling exists between the reference signal VRAMP and the output node of the buffer circuit 56 of each column. In transitioning from an all-column power-on state to a column circuit thinning-out operation, some of the column circuits are powered off. This may alter the amount of capacitive coupling associated with the reference signal VRAMP. As a result, the degree of change of the reference signal VRAMP with time (slope operation) may be altered, leading to inaccurate AD conversion and image quality degradation. This situation is described below.

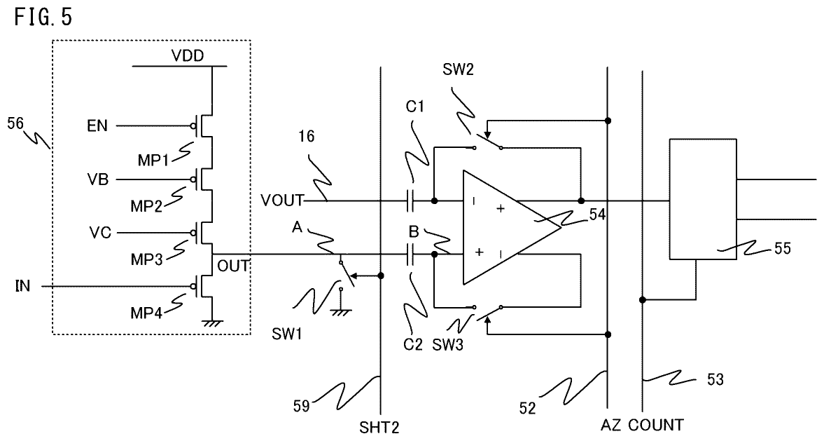

FIG. 5 shows the column circuit 51b. The column circuit 51b is a power-off column in a thinning-out operation, and the system control portion 90 can control the switch SW1, which fixes the potential of the output node of the buffer circuit 56 to a specific potential, by a control signal SHT2 via the signal line 59. Here, the output node of the buffer circuit 56 is represented as a node A, and the potential is represented as Va. The node A is connected to the capacitor C2, the other node on the side corresponding to the comparison circuit 54 is represented as B, and the potential is represented as Vb.

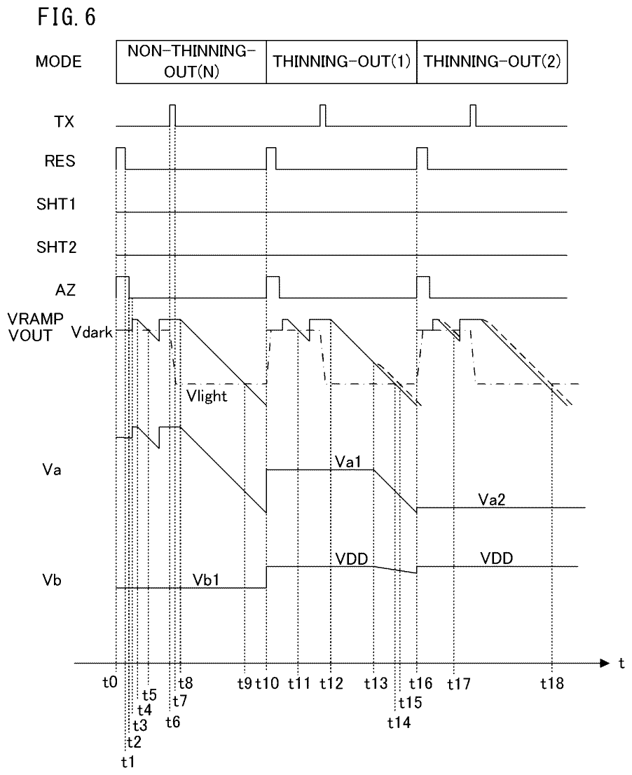

Referring to FIG. 6, a situation is now described where the imaging apparatus 100 transitions from an operation using all column circuits to a thinning-out operation. Here, in MODE, a non-thinning-out (N) period represents a period in which all column circuits are used, and thinning-out (1) period and thinning-out (2) period represent periods in which the thinning-out operation is performed. Furthermore, the control signals TX, RES, SEL, SHT1, SHT2, and AZ turn on the transistors or switches when the TX, RES, SEL, SHT1, SHT2, and AZ are at high level, and turn off the transistors or switches when they are at low level. The dashed dotted line indicates the signal VOUT of the vertical output line 16.

It is assumed that immediately before time t0, the control signal SEL (not shown) for the target row is at high level. As a result, the selection transistors M4 of the unit pixels 12 in that row are turned on, and each of these unit pixels 12 is in a state in which it can output a pixel signal to the vertical output line 16 in the corresponding column. In the period from time t0 to time t1, the vertical drive circuit 30 controls to set the control signal RES for the row to be read out to high level. As a result, the reset transistors M2 of the unit pixels 12 in that row are turned on, and the nodes FD are reset to a voltage corresponding to the voltage VDD. A signal Vdark having a voltage corresponding to the reset voltage of the node FD is output to the vertical output line 16.

During the period from time t0 to time t2, the system control portion 90 controls to set the control signal AZ to high level. As a result, the switches SW2 and SW3 of the column circuit 51 of each column are turned on, and the inverting input node and the non-inverting input node of the comparison circuit 54 are reset to the reset level voltage. That is, at time t2, one electrode of the capacitor C1 is at the voltage of the reset level of the signal VOUT, and the other electrode of the capacitor C1 is at the reset level of the comparison circuit 54. Also, one electrode of the capacitor C2 is at the reference voltage of the reference signal VRAMP, and the other electrode of the capacitor C2 is at the reset level voltage of the comparison circuit 54. The threshold voltage of the comparison circuit 54 is reset to a voltage corresponding to the potential difference between the reset level voltage of the signal VOUT and the reference voltage of the reference signal VRAMP.

The threshold voltage of the comparison circuit 54 is a voltage that corresponds to the difference between the signal level of the pixel signal and the signal level of the reference signal that occurs when the level of the comparison signal output from the comparison circuit 54 changes. That is, the comparison circuit 54 outputs a comparison signal indicating a different level depending on whether the difference between the signal level of the pixel signal and the signal level of the reference signal is less than the threshold voltage or greater than the threshold voltage. At time t2, the system control portion 90 controls to set the control signal AZ to low level. As a result, the switches SW2 and SW3 of the column circuit 51 of each column are turned off, the reset level of the signal VOUT is clamped to the capacitor C1, and the reference level corresponding to the reference voltage of the reference signal VRAMP is clamped to the capacitor C2.

At time t3, the reference signal generating circuit 50A increases the reference signal VRAMP from the reference voltage to a predetermined start voltage. Then, from time t4, a slope operation that changes with time starts. Also, the counter circuit 50B starts counting up at the same time as the start of the slope operation, and supplies a count signal COUNT indicating the count value to the column circuit 51 of each column via the count signal line 53.

The comparison circuit 54 compares the level of the signal VOUT, which is input via the capacitor C1, with the level of the reference signal VRAMP, which is input via the capacitor C2. The comparison circuit 54 inverts the level of the output signal at a time point when the magnitude relation between the level of the signal VOUT and the level of the reference signal VRAMP changes, for example, at time t5. As a result, as described above, the digital data is stored in the memory portion 55 and is transferred sequentially to the signal processing portion 70.

Subsequently, in the period from time t6 to time t7, the vertical drive circuit 30 controls to set the control signal TX of the readout target row to high level. This causes the transfer transistor M1 of each unit pixel 12 belonging to that row to be turned on, and the electric charge accumulated in the photoelectric conversion element PD during a predetermined exposure period is transferred to the node FD. As a result, the voltage of the node FD decreases according to the amount of electric charge transferred from the photoelectric conversion element PD, and the potential of the signal VOUT output to the vertical output line 16 also decreases to Vlight. A signal VOUT (pixel signal at the optical signal level) having a voltage corresponding to the voltage of the node FD is output to the vertical output line 16.

At time t8, the reference signal generating circuit 50A starts a slope operation in which the reference signal VRAMP changes with time. The counter circuit 50B starts counting up at the same time as the start of the slope operation, and supplies a count signal COUNT indicating the count value to the column circuit 51 of each column via the count signal line 53. The comparison circuit 54 compares the level of the signal VOUT, which is input via the capacitor C1, with the level of the reference signal VRAMP, which is input via the capacitor C2. The comparison circuit 54 inverts the level of the output signal at a time point when the magnitude relation between the level of the signal VOUT and the level of the reference signal VRAMP changes, for example, at time t9. As a result, as described above, the digital data is stored in the memory portion 55 and is transferred sequentially to the signal processing portion 70.

The digital data of the pixel signals thus obtained is subjected to correction processing through correlated double sampling in the signal processing portion 70 at the subsequent stage. In the correction processing through correlated double sampling, the digital data of the pixel signal at the reset level is subtracted from the digital data of the pixel signal at the optical signal level, and noise components superimposed on the pixel signal at the optical signal level are removed.

This operation sequence up to time t9 is repeated. FIG. 6 shows a case where, after the operation sequence from time t0 to time t9, the operation shifts to the thinning-out operation (MODE shifts from the Nth row of the non-thinning-out operation to the 1st row of the thinning-out operation). At this time, the comparison circuits 54 and the buffer circuits 56 in the column circuits 51b and 51d, which are not used in the thinning-out operation, are powered off by a power control signal (not shown). At this time, the output nodes A of the buffer circuits 56 in the column circuits 51b and 51d are floating. In other words, if, unlike the present embodiment, the function of fixing the potential using the switch SW1 is absent (the same as when the control signals SHT1 and SHT2 shown in FIG. 6 are always at low level), floating of the output node A may cause degradation of image quality. When the comparison circuit 54 is powered off, the inverting output node becomes VDD. At this time, the AZ signal line 52 becomes High, so that the potential Vb of the node B (non-inverting input node) on the side corresponding to the comparison circuit 54 also becomes VDD. Since the output node A of the buffer circuit 56 is floating, the potential Va rises to Va1 due to capacitive coupling by the capacitor C2.

As described above, the output node of the buffer circuit 56 has capacitive coupling with the input gate (reference signal VRAMP). Power-on columns differ from power-off columns in the capacitive coupling that exists with respect to the reference signal VRAMP, and the reference signal generating circuit 50A drives, for the power-off columns, the wiring that has capacitive coupling with Va1. At time t11, a comparison operation at the reset level is performed using the reference signal VRAMP from the reference signal generating circuit 50A. Then, from time t12, the reference signal VRAMP starts a slope operation for a comparison operation at the optical signal level. However, when the reference signal VRAMP decreases to a certain potential, such as at time t13, the P-type transistor MP4 (whose input gate receives the reference signal VRANP) in the buffer circuit 56 turns on. As a result, the potential Va1 of the floating output node A decreases to Va2 (˜ GND). Thus, the amount of capacitive coupling with the reference signal VRAMP is altered, and the amount of slope that changes with time is also altered (as shown by the dashed line of the reference signal VRAMP from time t13).

For example, the comparison circuit 54, which should originally invert the level of output signal at time t14, invert the level at time t15. As a result, the slope amount of the reference signal VRAMP, which changes with time, differs between the reset level and the optical signal level, preventing the correction processing from being performed through correct correlated double sampling.

The thinning-out operation in the second row is now described. At time t16, when the control signal AZ becomes high level, the node B (non-inverting input node) on the side corresponding to the comparison circuit 54 of the power-off column is at VDD at the first row of the thinning-out operation. As such, the output node A of the buffer circuit 56 is less affected to increase even when it is floating. As such, relative to the reset level, time t17 at which the comparison circuit 54 inverts the level of the output signal at the reset level, and time t18, at which the comparison circuit 54 inverts the level of the output signal level at the optical signal level, are determined by the amount of slope due to the same time change of the reference signal VRAMP. For this reason, only the first row of the thinning-out operation produces a peculiar output, causing degradation of image quality.

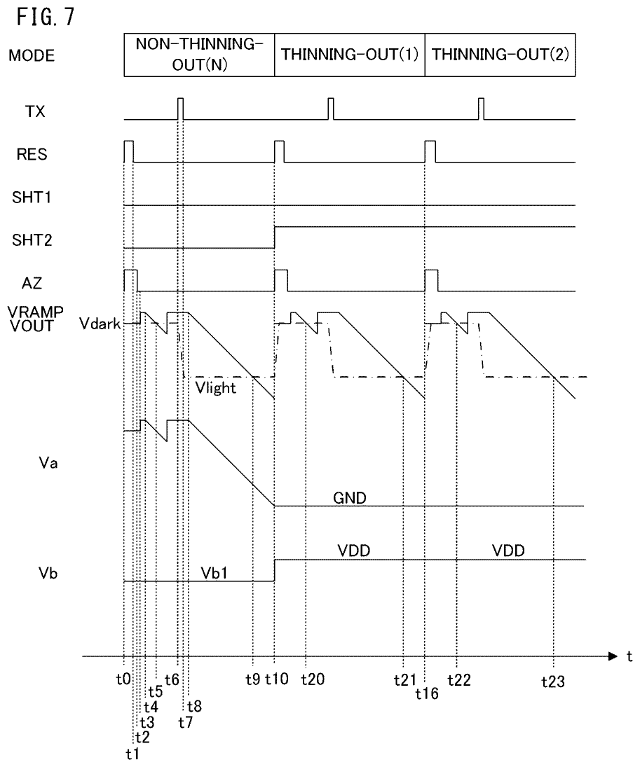

In FIG. 7, the operation of the switch SW1 prevents the output nodes of the buffer circuits 56 in the column circuits 51b and 51d from becoming floating. Description of the operation pulses similar to those in FIG. 6 is omitted. Control signals SHT1 and SHT2 are supplied via signal lines 58 and 59. The control signal SHT1 is constantly supplied at low level via the signal line 58, whereas the signal line 59 supplying the control signal SHT2 switches from low level to high level at time t10. As a result, the output nodes A of the buffer circuits 56 in the column circuits 51b and 51d are fixed to GND because SW1 is turned on. At time t10, the control signal AZ becomes high level, and the node B (non-inverting input node) on the side corresponding to the comparison circuit 54 of the power-off column becomes VDD. However, since the output node A of the buffer circuit 56 is fixed by the switch SW1, the potential Va does not rise due to capacitive coupling caused by the capacitor C2. That is, even in the first row of the thinning-out operation, the slope operation of the reference signal VRAMP is the same in the comparison operation at the reset level and in the comparison operation at the optical signal level. This allows the correction processing to be performed through correct correlated double sampling. This also applies to the second and subsequent rows of the thinning-out operation, so that it is possible to obtain the effect of reducing degradation in image quality.

Although the timing for powering off the column circuit 51 to perform a thinning-out operation is time t10 in the above description, the timing is not limited to this. Similarly, the timing for setting the control signal SHT2 to high level is not limited to time t10. For example, after power is turned off, the control signal SHT2 is set to high level before the slope operation of the reference signal VRAMP used for the first AD conversion at the reset level. This allows the comparison operation at the reset level and the comparison operation at the optical signal level to be performed with a matching slope operation of the reference signal VRAMP.

Also, the buffer circuits 56 of the present embodiment are P-type transistors, but there is no limitation to this. N-type transistors may also be used. Furthermore, the slope shape is not limited to a shape in which the potential decreases with time. Thus, as described above, the potential fixed by the switch SW1 is not limited to GND, but can be VDD or a predetermined intermediate potential. The optimal combination can be selected in accordance with the configuration of buffer circuit 56 and comparison circuit 54.

Furthermore, the reference signal VRAMP to be supplied is not limited to one type. For example, two types of signals having different slope amounts that change with time may be supplied. In this case, a configuration may be adopted in which each column circuit 51 includes buffer circuits 56 for reference signals VRAMP having the respective slope amount types.

### Second Embodiment

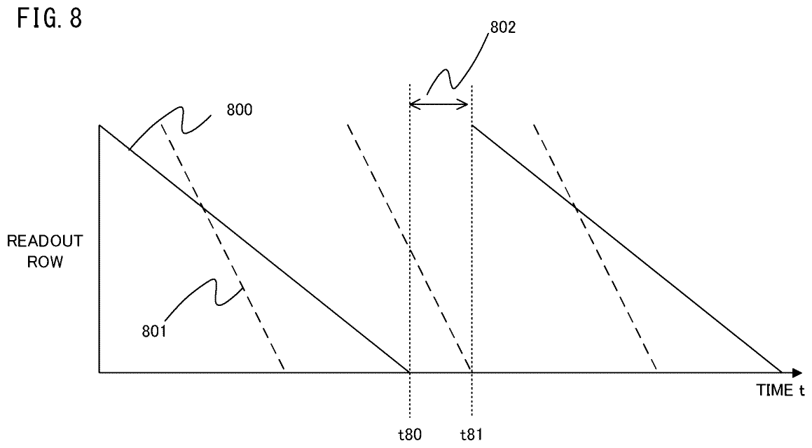

The present disclosure is also applicable to a configuration in which one column has multiple vertical output lines and image signals of multiple rows are scanned in parallel to be read out as image signals for display and image signals for sensing. In this case, the column circuit portion 50 includes column circuits 51 corresponding to the number of vertical output lines for display image signals and vertical output lines for sensing image signals. FIG. 8 shows how the display image signals and the sensing image signals are scanned in rows. The scanning of the display image signals (referred to as first scan, for example) is represented by 800, while the scanning of the sensing image signals (referred to as second scan, for example) is represented by 801. The first scan is scanning for reading out signals from unit pixels 12 in a portion of the rows among the multiple rows, and the second scan is scanning for reading out signals from unit pixels 12 in a different portion of the rows among the multiple rows. The period from the start to the end of the second scan is shorter than the period from the start to the end of the first scan. Also, the second scan is performed multiple times during the period from the start to the end of the first scan. The signals read out by this second scan enable the detection of the presence or absence of flicker in the captured scene. The signals read out in the second scan can be used for various purposes, such as detecting a moving object, in addition to detecting flicker. In the period from time t80 to time t81 represented as 802, scanning of the display image signal by 800 is not performed, and the column circuits from which display image signals are read out are powered off. In this case, the above-described image quality degradation may occur in the sensing image at time t80. As such, fixing the output node of the buffer circuit 56 achieves both the effect of reducing image quality degradation and high functionality.

In the following, a photoelectric conversion system, a moving body and equipment and the like according to embodiments are described.

### Third Embodiment

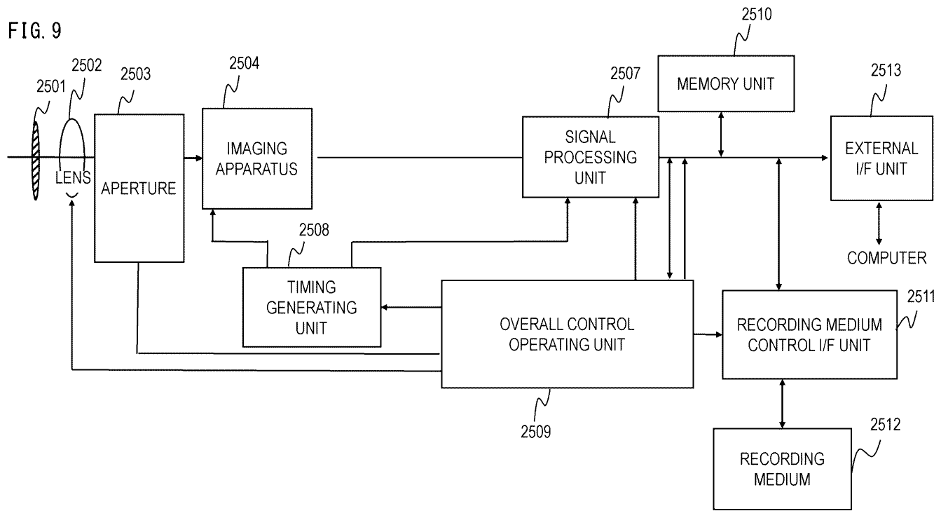

A photoelectric conversion system according to the present embodiment will be described with reference to FIG. 9. FIG. 9 is a block diagram showing a schematic configuration of the photoelectric conversion system according to the present embodiment.

The imaging apparatuses (examples of photoelectric conversion apparatuses) described in the first and second embodiments can be applied to various photoelectric conversion systems. Each of the photoelectric conversion systems includes at least the photoelectric conversion apparatuses according to any of the embodiments described above and a signal processing portion that processes signals output from the photoelectric conversion apparatus. Examples of devices to which such a photoelectric conversion system can be applied include a digital still camera, a digital camcorder, a monitoring camera, a copier, a facsimile, a mobile phone, a vehicle-mounted camera, an observation satellite, a sensor, and a measuring instrument. In addition, camera modules provided with an optical system such as a lens and an imaging apparatus are also included in devices to which a photoelectric conversion system is applied. FIG. 9 illustrates a block diagram of a digital still camera as an example of such devices.

The photoelectric conversion system illustrated in FIG. 9 has an imaging apparatus 2504 as an example of the photoelectric conversion apparatus and a lens 2502 that causes an optical image of a subject to be formed on the imaging apparatus 2504. In addition, the photoelectric conversion system has an aperture 2503 for making a light amount that passes through the lens 2502 variable and a barrier 2501 for protecting the lens 2502. The lens 2502 and the aperture 2503 are optical systems for collecting light to the imaging apparatus 2504. The imaging apparatus 2504 is the photoelectric conversion apparatus (imaging apparatus) according to any of the embodiments described above and converts an optical image having been formed by the lens 2502 into an electric signal.

The photoelectric conversion system also has a signal processing portion 2507 which is an image generating portion for generating an image by processing an output signal that is output from the imaging apparatus 2504. The signal processing portion 2507 performs operations in which the output signal is subjected to various corrections and compression when necessary and image data is output. The signal processing portion 2507 may be formed on a semiconductor substrate provided with the imaging apparatus 2504 or formed on a semiconductor substrate that is separate from the imaging apparatus 2504. In addition, the imaging apparatus 2504 and the signal processing portion 2507 may be formed on a same semiconductor substrate.

The photoelectric conversion system further has a memory portion 2510 for temporarily storing image data and an external interface portion (an external I/F portion) 2513 for communicating with an external computer or the like. Furthermore, the photoelectric conversion system has a recording medium 2512 such as a semiconductor memory for recording or reading imaging data and a recording medium control interface portion (a recording medium control I/F portion) 2511 for performing recording or reading with respect to the recording medium 2512. The recording medium 2512 may be built into the photoelectric conversion system or may be attachable to and detachable from the photoelectric conversion system.

Furthermore, the photoelectric conversion system has an overall control operating portion 2509 that performs various arithmetic operations and controls the entire digital still camera and a timing generating portion 2508 that outputs various timing signals to the imaging apparatus 2504 and the signal processing portion 2507. In this case, the timing signals and the like may be input from outside and the photoelectric conversion system need at least have the imaging apparatus 2504 and the signal processing portion 2507 that processes an output signal that is output from the imaging apparatus 2504.

The imaging apparatus 2504 outputs an imaging signal to the signal processing portion 2507. The signal processing portion 2507 performs predetermined signal processing on the imaging signal output from the imaging apparatus 2504 and outputs image data. The signal processing portion 2507 generates an image using the imaging signal.

As described above, according to the present embodiment, a photoelectric conversion system to which the photoelectric conversion apparatus according to any of the embodiments described above is applied can be realized.

### Fourth Embodiment

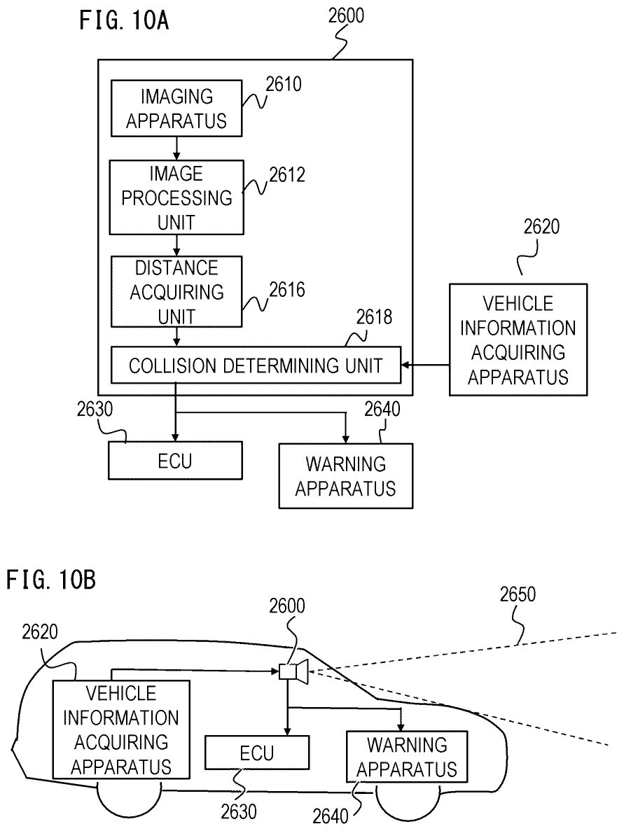

A photoelectric conversion system and a moving body according to the present embodiment will be described with reference to FIGS. 10A and 10B. FIG. 10A is a diagram showing a configuration of the photoelectric conversion system according to the present embodiment and FIG. 10B is a diagram showing a configuration of the moving body according to the present embodiment.

FIG. 10A shows an example of a photoelectric conversion system related to a vehicle-mounted camera. A photoelectric conversion system 2600 includes an imaging apparatus 2610 to which the photoelectric conversion apparatus (imaging apparatus) described in any one of the embodiments described above is applied. The photoelectric conversion system 2600 has an image processing unit 2612 that performs image processing on a plurality of pieces of image data acquired by the imaging apparatus 2610. In addition, the photoelectric conversion system 2600 has a distance acquiring unit 2616 that calculates a distance to an object and a collision determining unit 2618 that determines whether or not there is a possibility of a collision based on the calculated distance. In this case, the distance acquiring unit 2616 may acquire information on the distance to the object based on a ToF (Time of Flight) or may acquire distance information using parallax information or the like. Furthermore, the distance acquiring unit 2616 may acquire distance information by combining ranging according to ToF and ranging based on a phase difference between pixels. In other words, distance information is information related to a parallax, a defocus amount, a distance to the object, or the like. The collision determining unit 2618 may determine a possibility of a collision using any of these pieces of distance information. The distance information acquiring means may be realized by exclusively-designed hardware or may be realized by a software module. Alternatively, the distance information acquiring means may be realized by an FPGA (Field Programmable Gate Array), an ASIC (Application Specific Integrated Circuit), or the like, or a combination thereof.

The photoelectric conversion system 2600 is connected to a vehicle information acquiring apparatus 2620 and is capable of acquiring vehicle information such as a vehicle speed, a yaw rate, and a steering angle. In addition, an ECU 2630 which is a control apparatus that outputs a control signal causing a vehicle to generate a braking force based on a determination result of the collision determining unit 2618 is connected to the photoelectric conversion system 2600. Furthermore, the photoelectric conversion system 2600 is also connected to a warning apparatus 2640 that issues a warning to a driver based on a determination result of the collision determining unit 2618. For example, when it is found that the possibility of a collision is high as a determination result of the collision determining unit 2618, the ECU 2630 performs vehicle control involving applying the brakes, releasing the gas pedal, suppressing engine output, or the like to avoid a collision and/or reduce damage. The warning apparatus 2640 issues a warning to a user by sounding an alarm, displaying warning information on a screen of a car navigation system or the like, vibrating a seat belt or a steering wheel, or the like.

In the present embodiment, an image of a periphery of the vehicle such as the front or the rear of the vehicle is picked up by the photoelectric conversion system 2600. FIG. 10B shows the photoelectric conversion system when imaging of the front of the vehicle (an imaging range 2650) is performed. The vehicle information acquiring apparatus 2620 sends an instruction to the photoelectric conversion system 2600 or the imaging apparatus 2610. According to such a configuration, accuracy of ranging can be further improved.

While an example of controlling a vehicle so as to prevent a collision with another vehicle has been described above, the photoelectric conversion system can also be applied to controlling automated driving so that the vehicle follows another vehicle, controlling automated driving so that the vehicle stays within a lane, and the like. In addition, the photoelectric conversion system is not limited to a vehicle such as an automobile and can also be applied to a moving body (moving apparatus) such as a ship, an airplane, or an industrial robot. The moving body includes one of or both of a driving force generating unit that generates a driving force mainly used for movement of the moving body and a rotating member that is mainly used for movement of the moving body. The driving force generating unit can be an engine, a motor, or the like. The rotating member can be a tire, a wheel, a screw of a ship, a propeller of a flight vehicle, or the like. Moreover, besides moving bodies, the photoelectric conversion system can be applied to a wide variety of apparatuses that utilize object recognition such as an intelligent transportation system (ITS).

### Fifth Embodiment

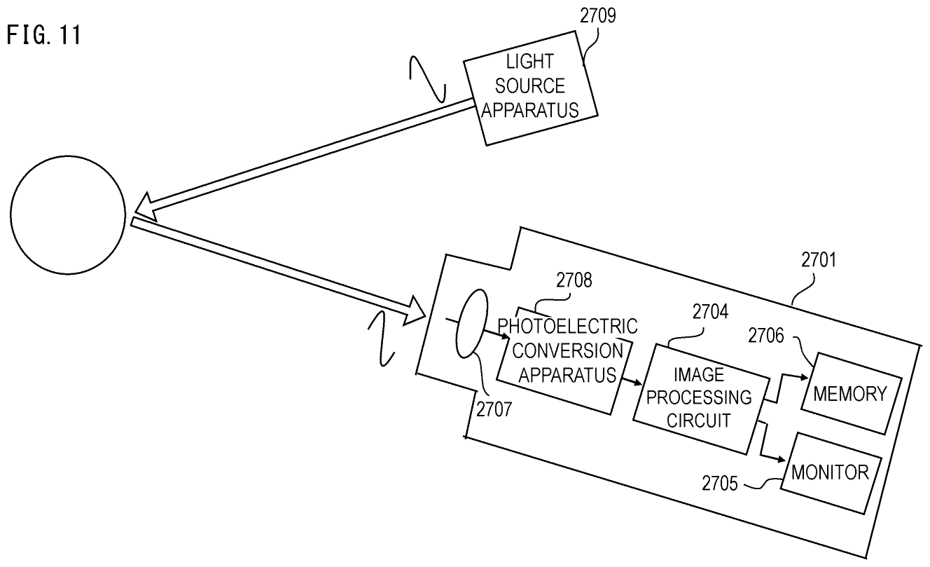

A photoelectric conversion system according to the present embodiment will be described with reference to FIG. 11. FIG. 11 is a block diagram showing a configuration example of a distance image sensor that is the photoelectric conversion system according to the present embodiment.

As shown in FIG. 11, a distance image sensor 2701 is configured to include an optical system 2707, a photoelectric conversion apparatus 2708, an image processing circuit 2704, a monitor 2705, and a memory 2706. In addition, the distance image sensor 2701 is capable of acquiring a distance image in accordance with a distance to a subject by receiving light (modulated light or pulsed light) emitted toward the subject from a light source apparatus 2709 and reflected by a surface of the subject.

The optical system 2707 is configured with one or a plurality of lenses and guides image light (incident light) from the subject to the photoelectric conversion apparatus 2708 and forms an image on a light-receiving surface (a sensor unit) of the photoelectric conversion apparatus 2708.

The image processing circuit 2704 performs image processing for constructing a distance image based on the distance signal supplied from the photoelectric conversion apparatus 2708. In addition, a distance image (image data) obtained by the image processing is supplied to and displayed by the monitor 2705 or supplied to and stored (recorded) in the memory 2706.

With the distance image sensor 2701 configured as described above, applying one of the photoelectric conversion apparatuses described above enables, for example, a more accurate distance image to be acquired due to an improvement in ranging accuracy.

### Sixth Embodiment

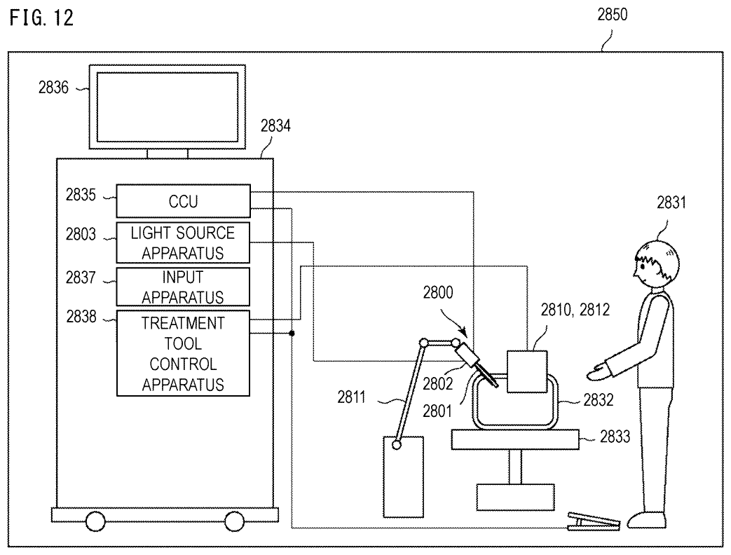

A photoelectric conversion system according to the present embodiment will be described with reference to FIG. 12. FIG. 12 is a diagram showing an example of a schematic configuration of an endoscopic surgery system that is the photoelectric conversion system according to the present embodiment.

FIG. 12 illustrates a situation where a technician (a physician) 2831 is using an endoscopic surgery system 2850 to operate on a patient 2832 on a patient bed 2833. As illustrated, the endoscopic surgery system 2850 is constituted of an endoscope 2800, a surgical instrument 2810, and a cart 2834 mounted with various apparatuses for an endoscopic surgery.

The endoscope 2800 is constituted of a lens barrel 2801 of which a region with a predetermined length from a distal end is to be inserted into a body cavity of the patient 2832 and a camera head 2802 connected to a base end of the lens barrel 2801. While the illustrated example features the endoscope 2800 being configured as a so-called rigid scope having a rigid lens barrel 2801, alternatively, the endoscope 2800 may be configured as a so-called flexible scope having a flexible lens barrel.

An opening into which an objective lens is fitted is provided at the distal end of the lens barrel 2801. A light source apparatus 2803 is connected to the endoscope 2800, and light generated by the light source apparatus 2803 is guided to the distal end of the lens barrel 2801 by a light guide provided so as to extend inside the lens barrel and emitted toward an observation object inside a body cavity of the patient 2832 via the objective lens. It should be noted that the endoscope 2800 may be a forward-viewing endoscope, an oblique-viewing endoscope, or a side-viewing endoscope.

An optical system and a photoelectric conversion apparatus are provided inside the camera head 2802 and reflected light (observation light) from the observation object is collected to the photoelectric conversion apparatus by the optical system. The observation light is photoelectrically converted by the photoelectric conversion apparatus and an electric signal corresponding to the observation light or, in other words, an image signal corresponding to an observed image is generated. As the photoelectric conversion apparatus, the photoelectric conversion apparatus according to any one of the embodiments described above can be used. The image signal is transmitted to a Camera Control Unit (CCU) 2835 as RAW data.

The CCU 2835 is constituted of a CPU (Central Processing Unit), a GPU (Graphics Processing Unit), or the like and comprehensively controls operations of the endoscope 2800 and a display apparatus 2836. In addition, the CCU 2835 receives an image signal from the camera head 2802 and subjects the image signal to various kinds of image processing for displaying an image based on the image signal such as development processing (demosaicing).

Under control exerted by the CCU 2835, the display apparatus 2836 displays an image based on the image signal subjected to image processing by the CCU 2835. The light source apparatus 2803 is constituted of a light source such as an LED (Light-Emitting Diode) and supplies the endoscope 2800 with irradiation light used when photographing a surgical site or the like.

An input apparatus 2837 is an input interface with respect to the endoscopic surgery system 2850. A user can input various kinds of information and input instructions to the endoscopic surgery system 2850 via the input apparatus 2837.

A treatment tool control apparatus 2838 controls drive of an energy treatment tool 2812 for cauterizing or incising tissue, sealing a blood vessel, or the like.

The light source apparatus 2803 that supplies the endoscope 2800 with irradiation light when photographing a surgical site can be constituted of a white light source constituted of an LED, a laser light source, or a combination thereof. When the white light source is constituted of a combination of RGB laser light sources, since output intensity and an output timing of each color (each wavelength) can be controlled with high accuracy, white balance of a captured image can be adjusted in the light source apparatus 2803. In addition, in this case, an image corresponding to each of RGB can be captured in a time-divided manner by having an observation object be irradiated with laser light from each of the RGB laser light sources in a time-divided manner and controlling drive of an imaging element of the camera head 2802 in synchronization with the irradiation timing. According to this method, a color image can be obtained without having to provide the imaging element with a color filter.

In addition, drive of the light source apparatus 2803 may be controlled such that intensity of output light changes at predetermined intervals. By controlling drive of imaging elements of the camera head 2802 in synchronization with a timing at which the intensity of light changes to acquire images in a time-divided manner and compositing the images, an image with a high dynamic range that is free of so-called blocked-up shadows and blown-out highlights can be generated.

Furthermore, the light source apparatus 2803 may be configured to be capable of supplying light in a predetermined wavelength band that accommodates special light observation. In special light observation, for example, wavelength dependence of absorption of light by body tissue is utilized. Specifically, predetermined tissue such as a blood vessel of a superficial portion of a mucous membrane is photographed with high contrast by irradiating light with a narrower band than irradiation light during normal observation (in other words, white light). Alternatively, in special light observation, fluorescent observation may be performed in which an image is obtained using fluorescent light generated by irradiating excitation light. In fluorescent observation, body tissue may be irradiated with excitation light and fluorescent light from the body tissue can be observed, a reagent such as indocyanine green (ICG) can be locally injected into body tissue and the body tissue can be irradiated with excitation light corresponding to a fluorescent wavelength of the reagent to obtain a fluorescent image, and the like. The light source apparatus 2803 may be configured to be capable of supplying narrow-band light and/or excitation light that accommodates such special light observation.

### Seventh Embodiment

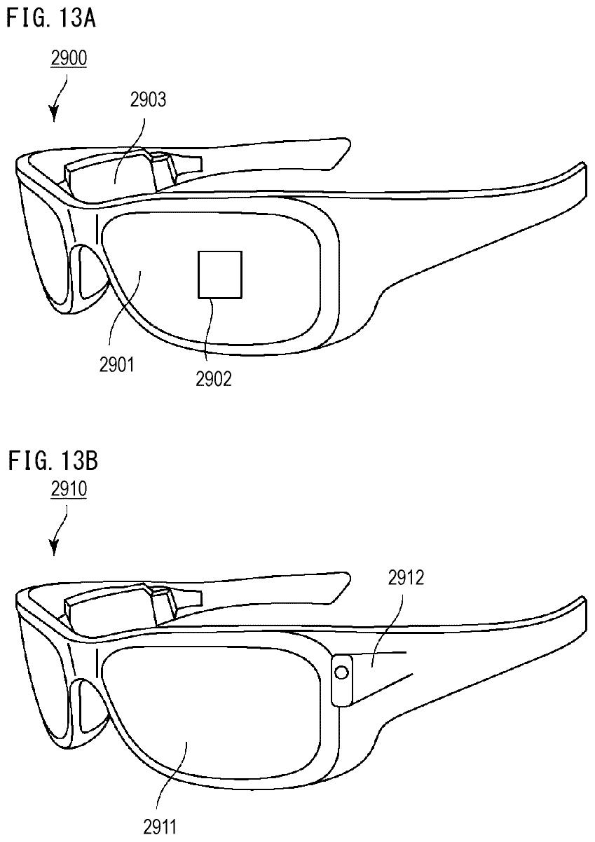

A photoelectric conversion system according to the present embodiment will be described with reference to FIGS. 13A and 13B. FIG. 13A illustrates eyeglasses (smart glasses) 2900 that is the photoelectric conversion system according to the present embodiment. The eyeglasses 2900 have a photoelectric conversion apparatus 2902. The photoelectric conversion apparatus 2902 is the photoelectric conversion apparatus (imaging apparatus) according to any one of the embodiments described above. In addition, a display apparatus including a light-emitting apparatus such as an OLED or an LED may be provided on a rear surface side of a lens 2901. There may be one or a plurality of photoelectric conversion apparatuses 2902. Alternatively, a plurality of types of photoelectric conversion apparatuses may be used in combination. An arrangement position of the photoelectric conversion apparatus 2902 is not limited to that shown in FIG. 13A.

The eyeglasses 2900 further include a control apparatus 2903. The control apparatus 2903 functions as a power source that supplies power to the photoelectric conversion apparatus 2902 and the display apparatus described above. In addition, the control apparatus 2903 controls operations of the photoelectric conversion apparatus 2902 and the display apparatus. An optical system for collecting light to the photoelectric conversion apparatus 2902 is formed in the lens 2901.

FIG. 13B illustrates eyeglasses (smart glasses) 2910 according to one application example. The eyeglasses 2910 include a control apparatus 2912 and the control apparatus 2912 is mounted with a photoelectric conversion apparatus that corresponds to the photoelectric conversion apparatus 2902 and a display apparatus. An optical system for projecting light emitted from the photoelectric conversion apparatus inside the control apparatus 2912 and the display apparatus is formed in the lens 2911 and an image is projected onto the lens 2911. The control apparatus 2912 functions as a power source that supplies power to the photoelectric conversion apparatus and the display apparatus and, at the same time, controls operations of the photoelectric conversion apparatus and the display apparatus. The control apparatus may have a line-of-sight detecting unit that detects a line-of-sight of a wearer. Infrared light may be used to detect a line-of-sight. An infrared light-emitting unit emits infrared light to the eyes of a user who is looking at a display image. A picked-up image of the eyes can be obtained by having an imaging unit including a light-receiving element detect reflected light from the eyes of emitted infrared light. Providing reducing means that reduces light from the infrared light-emitting unit to the display unit in a plan view enables a decline in image quality to be mitigated.

A line-of-sight of the user with respect to a display image can be detected from a picked-up image of eyes obtained by imaging with infrared light. Any known method can be applied to line-of-sight detection using a picked-up image of the eyes. For example, a line-of-sight detection method based on a Purkinje image due to reflection of irradiation light by the cornea can be used.

More specifically, line-of-sight detection processing based on a pupil-corneal reflection method is performed. Using the pupil-corneal reflection method, a line-of-sight of a user is detected by calculating a line-of-sight vector that represents an orientation (a rotation angle) of the eyes based on an image of a pupil included in a picked-up image of the eyes and a Purkinje image.

The display apparatus according to the present embodiment may have a photoelectric conversion apparatus including a light-receiving element and a display image of the display apparatus may be controlled based on line-of-sight information of the user from the photoelectric conversion apparatus.

Specifically, the display apparatus determines, based on the line-of-sight information, a first field-of-view region which the user focuses on and a second field-of-view region other than the first field-of-view region. The first field-of-view region and the second field-of-view region may be determined by the control apparatus of the display apparatus or regions determined by an outside control apparatus may be received as the first field-of-view region and the second field-of-view region. In a display region of the display apparatus, a display resolution of the first field-of-view region may be controlled to be higher than a display resolution of the second field-of-view region. In other words, the resolution of the second field-of-view region may be set lower than that of the first field-of-view region.

In addition, the display region may have a first display region and a second display region that differs from the first display region, and a region with high priority may be determined from the first display region and the second display region based on line-of-sight information. The first display region and the second display region may be determined by the control apparatus of the display apparatus or regions determined by an outside control apparatus may be received as the first display region and the second display region. A resolution of a region with high priority may be controlled to be higher than a resolution of a region other than the region with high priority. In other words, a resolution of a region of which a priority is relatively low can be lowered.

It should be noted that an AI (Artificial Intelligence) may be used to determine the first field-of-view region and a region with high priority. The AI may be a model configured to use an image of the eyes and a direction actually viewed by the eyes in the image as teacher data to estimate, from the image of the eyes, an angle of a line-of-sight and a distance to an object ahead of the line-of-sight. An AI program may be included in the display apparatus, the photoelectric conversion apparatus, or an external apparatus. When the external apparatus includes an AI program, an inference result by an AI is sent to the display apparatus via communication.

Display control based on visual recognition and detection can be preferably applied to smart glasses further including a photoelectric conversion apparatus that captures images of the outside. The smart glasses are capable of displaying captured external information in real-time.

### Eighth Embodiment

The photoelectric conversion apparatuses and the photoelectric conversion systems described above can be applied to, for example, electronic devices such as so-called smartphones and tablets.

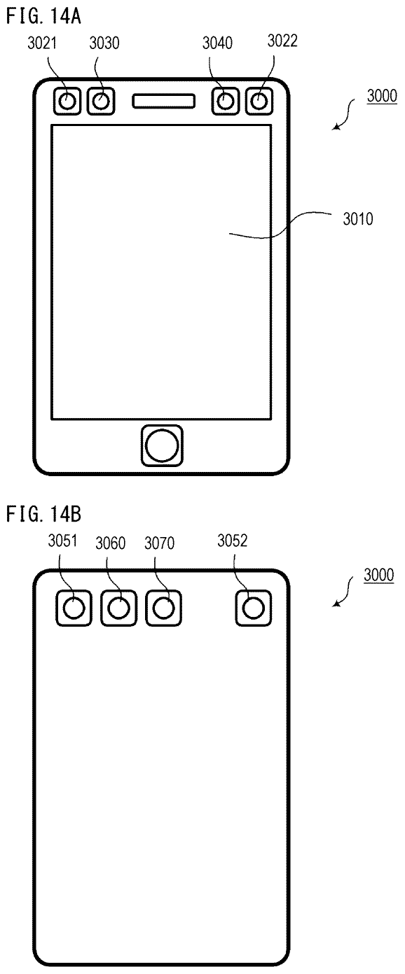

FIGS. 14A and 14B are diagrams showing an example of an electronic device 3000 to which a photoelectric conversion apparatus is mounted. FIG. 14A shows a front surface side of the electronic device 3000 and FIG. 14B shows a rear surface side of the electronic device 3000.

As shown in FIG. 14A, a display 3010 that displays an image is arranged at a center of the front surface of the electronic device 3000. In addition, front cameras 3021 and 3022 that use the photoelectric conversion apparatus, an IR light source 3030 that emits infrared light, and a visible light source 3040 that emits visible light are arranged along an upper side of the front surface of the electronic device 3000.

Furthermore, as shown in FIG. 14B, rear cameras 3051 and 3052 that use the photoelectric conversion apparatus, an IR light source 3060 that emits infrared light, and a visible light source 3070 that emits visible light are arranged along an upper side of the rear surface of the electronic device 3000.

In the electronic device 3000 configured as described above, by applying the photoelectric conversion apparatus described above, for example, an image with higher quality can be captured and a distance to a subject can be measured with high accuracy. Note that the photoelectric conversion apparatus can be applied to other electronic devices such as an infrared sensor, a ranging sensor using an active infrared light source, a security camera, and a personal authentication camera or a biometric camera. As a result, accuracy and performance of such electronic devices can be improved.

### Ninth Embodiment

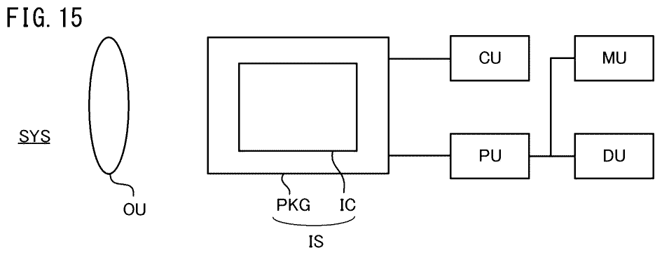

A photoelectric conversion system as an example of equipment according to a ninth embodiment will be described with reference to FIG. 15. FIG. 15 is a block diagram showing a schematic configuration of an imaging system SYS that is the photoelectric conversion system according to the ninth embodiment. The imaging system SYS includes at least the photoelectric conversion apparatus according to any one of the embodiments described above and a signal processing unit that processes signals output from the photoelectric conversion apparatus.

The imaging system SYS is an information terminal that includes a camera and a photography function. The imaging system SYS is constructed using an imaging apparatus IS. The imaging apparatus IS can further include a package PKG that houses an imaging device IC. The package PKG can include a substrate on which the imaging device IC is fixed and a lid body that opposes the imaging device IC. The package PKG can include a connecting member (a member that connects a terminal provided on the substrate and a terminal provided on the imaging device IC) to each other. The imaging apparatus IS can mount a plurality of the imaging devices IC to a common package PKG by arranging the imaging devices IC side by side. Alternatively, the imaging apparatus IS can mount the imaging device IC and another semiconductor device IC to a common package PKG by stacking the imaging device IC and the semiconductor device IC on top of each other.

The imaging system SYS can include an optical system OU (optical apparatus) that forms an image on the imaging apparatus IS. In addition, the imaging system SYS can include at least any of a control apparatus CU, a processing apparatus PU, a display apparatus DU, and a storage apparatus MU. The control apparatus CU controls the imaging apparatus IS and the processing apparatus PU processes a signal obtained from the imaging apparatus IS. Furthermore, the display apparatus DU displays an image obtained from the imaging apparatus IS and the storage apparatus MU stores the image obtained from the imaging apparatus IS.

### OTHER EMBODIMENTS

Although various apparatuses have been described in the above embodiments, mechanical apparatuses may also be included. The mechanical apparatus in a camera can drive the components of the optical system for zooming, focusing, and shutter operation. Alternatively, the mechanical apparatus in the camera may move the photoelectric conversion apparatus for vibration isolation operation.

Furthermore, the equipment may be transportation equipment such as a vehicle, a ship, or a flying object. The mechanical apparatus in transportation equipment can be used as a moving device. The equipment as transportation equipment is suitable to transport the photoelectric conversion apparatus, and to assist and/or automate the driving (maneuvering) using an imaging function. A processor for assisting and/or automating driving (maneuvering) may perform a process for operating the mechanical apparatus as a moving device based on the information obtained by the photoelectric conversion apparatus.

The embodiments described above can be modified as appropriate without departing from the technical idea. In addition, the disclosure of the present specification encompasses not only the items specified herein but also all items identifiable from the descriptions in this specification and the drawings attached to this specification.

According to the present invention, it is possible to reduce deterioration in image quality caused by fluctuations in the output node of a floating buffer circuit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-063924, filed on Apr. 11, 2024, which is hereby incorporated by reference herein in its entirety.

What is claimed is:

1. A photoelectric conversion apparatus comprising:
a plurality of pixels arranged across a plurality of rows and a plurality of columns;
a plurality of column circuits corresponding to the plurality of columns respectively; and
a control portion, wherein
each of the plurality of column circuits includes:
a comparison circuit including a first input node to which a pixel signal is input from a plurality of pixels in a column corresponding thereto, and a second input node to which a reference signal is input; and
a buffer circuit including an output node for outputting the reference signal to the comparison circuit of the column corresponding thereto, and
the control portion is capable of controlling a potential of the output node of the buffer circuit included in each of the plurality of column circuits to a predetermined potential.

2. The photoelectric conversion apparatus according to claim 1, wherein the control portion is configured to, during a period in which a power consumption of the buffer circuit of at least one of the plurality of column circuits is controlled to be less than a power consumption of the buffer circuits of at least another one of the plurality of column circuits, control a potential of the output node of the buffer circuit of the at least one of the plurality of column circuits to the predetermined potential.

3. The photoelectric conversion apparatus according to claim 1, wherein the control portion is configured to, during a period in which a power consumption of the buffer circuit included in the column circuit corresponding to one of an odd-numbered column and an even-numbered column among the plurality of column circuits is controlled to be less than a power consumption of the buffer circuit included in the column circuit corresponding to the other of the odd-numbered column and the even-numbered column, control a potential of the output node of the buffer circuit included in the column circuit corresponding to the one of the odd-numbered column and the even-numbered column to the predetermined potential.

4. The photoelectric conversion apparatus according to claim 2, wherein a signal line configured to input to the at least one of the plurality of column circuits a control signal for controlling the potential of the output node of the buffer circuit of the at least one of the plurality of column circuits to the predetermined potential is independent of a signal line configured to input the control signal to the at least another one of the plurality of column circuits.

5. The photoelectric conversion apparatus according to claim 1, wherein the predetermined potential is GND.

6. The photoelectric conversion apparatus according to claim 2, wherein after the power consumption of the buffer circuit of the at least one of the plurality of column circuits is controlled to be less than the power consumption of the buffer circuit of the at least another one of the plurality of column circuits and before a slope operation of the reference signal starts, the control portion is configured to fix the output node of the buffer circuit of the at least one of the plurality of column circuits to the predetermined potential.

7. The photoelectric conversion apparatus according to claim 1, wherein
during a period in which first scan is performed to read out a signal from pixels in a portion of the rows among the plurality of rows, second scan is performed to read out a signal from a pixel in a different portion of the rows among the plurality of rows, and
a period from start to end of the second scan is shorter than a period from start to end of the first scan.

8. A photoelectric conversion system comprising:
the photoelectric conversion apparatus according to claim 1; and
a signal processing portion configured to generate an image by using a signal output from the photoelectric conversion apparatus.

9. A moving body comprising the photoelectric conversion apparatus according to claim 1, the moving body comprising
a control portion configured to control movement of the moving body by using a signal output from the photoelectric conversion apparatus.

10. Equipment comprising:
the photoelectric conversion apparatus according to claim 1; and
at least any of:
an optical apparatus corresponding to the photoelectric conversion apparatus;
a control apparatus that controls the photoelectric conversion apparatus;
a processing apparatus that processes a signal output from the photoelectric conversion apparatus;
a display apparatus that displays information obtained by the photoelectric conversion apparatus;
a storage apparatus that stores information obtained by the photoelectric conversion apparatus; and
a mechanical apparatus that operates on a basis of information obtained by the photoelectric conversion apparatus.

11. A method of driving a photoelectric conversion apparatus, wherein
the photoelectric conversion apparatus includes:
a plurality of pixels arranged across a plurality of rows and a plurality of columns;
a plurality of column circuits corresponding to the plurality of columns respectively; and
a control portion,
each of the plurality of column circuits includes:
a comparison circuit including a first input node to which a pixel signal is input from a plurality of pixels in a column corresponding thereto, and a second input node to which a reference signal is input; and
a buffer circuit including an output node for outputting the reference signal to the comparison circuit of the column corresponding thereto, and
the method comprises:
controlling the buffer circuit by the control portion between a first state in which the buffer circuit operates and a second state in which a power consumption of the buffer circuit is less than that in the first state; and
setting by the control portion a potential of the output node of the buffer circuit to a predetermined potential during a period in which the buffer circuit is controlled to the second state.
